(19) United States
(12) Patent Application Publication
(10) Pub. No.: US 2009/0237290 A1
(43) Pub. Date: Sep. 24, 2009

(54) RADAR TRANSPONDER

(76) Inventor: Michael Kishinevsky, (US)

Correspondence Address: INTELLECTUAL PROPERTY LAW OFFICE OF JOEL VOELZKE, 24772 SADDLE PEAK ROAD, MALIBU, CA, 90265, US

(21) Appl. No.: 12/340,566

(22) Filed: Dec. 19, 2008

Related U.S. Application Data
(60) Provisional application No. 61/015,179, filed on Dec. 19, 2007.

(51) Int. Cl. G01S 13/74

(52) U.S. Cl. 342/51

(57) ABSTRACT

A radar transponder which does not have a receiver/transmit switch. A radio frequency coupler of the transponder switches the antenna between the transmitter and the receiver. The coupler connects the receiver, the transmitter and the antenna such that the receiver is connected to the most attenuated terminal of the coupler. The coupler may be a radio frequency coupler having an attenuation of between three and forty dB, or approximately ten dB. The antenna can be an integrated PCB surface-mounted multi-bay turnstile antenna.

### CROSS-REFERENCE TO RELATED APPLICATIONS

This application claims priority to provisional application Ser. No. 61/015,179, filed Dec. 19, 2007 and whose entire contents are hereby incorporated by reference.

### NOTICE OF COPYRIGHTS AND TRADE DRESS

A portion of the disclosure of this patent document contains material which is subject to copyright protection. Also, this patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

Search and Rescue Transponders (SARTs) use switching devices that switch the antenna between the receiver and the transmitter. These switches are expensive, significantly contributing to the overall cost of the system.

### BRIEF DESCRIPTION OF THE DRAWINGS

FIG. 1 is a simplified block diagram of a transponder for use as a SART, PRB and the like.

FIGS. 2A, 2B and 2C are drawings of transponder responses at different ranges.

FIG. 3 is a block diagram showing the relative positions of FIGS. 3A-3I.

FIGS. 3A-3I together form a schematic of the transponder, with reference to FIG. 3; the components of the schematic may be mounted on a printed circuit board

FIG. 4 is a block diagram representation of the components shown by the dotted line blocks in FIGS. 3A-3I; and the dotted lines in FIG. 4 correspond to the blocks of FIG. 1.

FIG. 5 is a block diagram of the CPLD shown in FIG. 3A.

FIG. 6 is a perspective view of an antenna of the transponder, such as depicted in FIG. 1.

FIG. 7 is a perspective view of an enclosure of the transponder.

### DETAILED DESCRIPTION

SARTs are used to locate survivors during search and rescue operations. When activated, the SART allows a survival craft (or person) to appear on a search vessel's radar display as an easily-recognized series of dots. Radars are carried by most ships and are used to determine the presence and location of an object by measuring the time for the echo of a radio wave to return from it and the direction from which it returns. A typical ship's radar will transmit a stream of high power pulses on a fixed frequency anywhere between 9.2 GHz and 9.5 GHz. It collects the echoes received on the same frequency using a display known as a Plan Position Indicator (PPI), which shows the ship itself at the center of the screen, with the echoes dotted around it. Echoes further from the center of the screen are thus further from the ship and the relative or true bearing of each echo can be easily seen.

The SART operates by receiving a pulse from the search radar and sending back a series of pulses in response, which the radar will then display as if they were normal echoes. The first return pulse, if it is sent back immediately, will appear in the same place on the PPI as a normal echo would have done. Subsequent pulses, being slightly delayed, appear to the radar-like echoes from objects further away. A series of dots is therefore shown, leading away from the position of the SART. This distinctive pattern is much easier to spot than a single echo such as from a radar reflector. Moreover, the fact that the SART is actually a transmitter means that the return pulses can be as strong as echoes received from much larger objects. A complication arises from the need for the SART to respond to radars which may be operating at any frequency within the 9 GHz band. The method chosen for the SART is to use a wideband receiver (which will pick up any radar pulses in the band), in conjunction with a swept frequency transmitter. Each radar pulse received by the SART results in a transmission consisting of twelve forward and return sweeps through the range 9.2 GHz to 9.5 GHz. The radar will only respond to returns close to its own frequency of operation (i.e., within its receive bandwidth), so a “pulse” is produced at the radar input each time the SART sweep passes through the correct frequency.

On a long range setting, a typical radar will be triggering the SART every millisecond, but only during the period that the rotating radar scanner is pointing in the correct direction. Most modern radars use sophisticated noise rejection techniques, which prevent the display of echoes which are not synchronized with the radar's own transmissions, so one radar will not normally be confused by a SART's response to another radar. The SART indicates that it has been triggered by lighting an indicator LED continuously (it flashes in standby mode) and by sounding an integral buzzer. If no radar pulses are detected for a period exceeding fifteen seconds, the SART reverts to “standby” mode.

When looking for a SART it is preferable to use a radar range scale between six and twelve nautical miles. This is because the spacing between the SART responses is about 0.6 nautical miles (1125 meters) and it is necessary to see a number of responses to distinguish the SART from other responses.

There are inherent delays in the SART responses; the SART has a trigger delay and may also have to sweep through the whole radar band before reaching the frequency of the search radar. At medium ranges of about six nautical miles the range delay may be between about one hundred and fifty meters and 0.6 nautical mile beyond the SART position. As the SART is approached, the radar delay of the first dot should be no more than one hundred and fifty meters beyond the SART position.

The radar bandwidth is normally matched to the radar pulse length and is usually switched with the range scale and the associated pulse length. Narrow bandwidths of 3.5 MHz are used with long pulses on long range and wide bandwidths of 10-25 MHz with short pulses on short ranges. Any radar bandwidth of less than 5 MHz will attenuate the SART signal slightly so it is preferable to use a medium bandwidth to ensure optimum detection of the SART.

If the SART is in the sidelobes of the radar antenna, the radar may show the SART responses as a series of arcs or concentric rings. These can be removed by the use of the anti-clutter sea control although it may be operationally useful to observe the side lobes as these will confirm that the SART is near to the ship

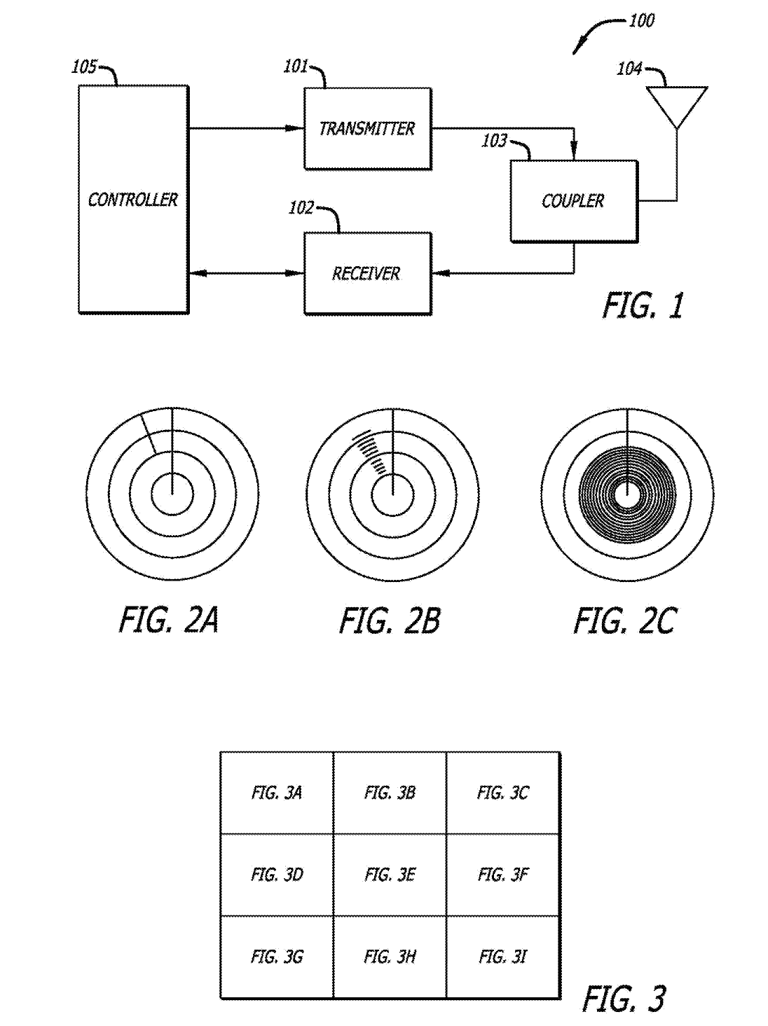

To increase the visibility of the SART in clutter conditions the radar may be detuned to reduce the clutter without reducing the SART response. Radar with automatic frequency control may not permit manual detuning of the equipment. Care should be taken in operating the radar detuned, as other wanted navigational and anti-collision information may be removed. The tuning should be returned to normal operation as soon as possible. FIG. 1 shows a block diagram of an embodiment of a transponder 100 for use as a SART, PRB, and the like. In the transponder, 100, a transmitter and a receiver are provided to a radio-frequency coupler 103. The coupler 103 is provided to an antenna 104. Unlike prior art devices, the transponder of FIG. 1 does not use a transmit/receive switch to switch the antenna 104 between the transmitter and the receiver 102. The controller 104 controls the transmitter 101 and the receiver 102. The coupler 103 couples a portion of the energy received by the antenna 104 to the receiver 102. As described in detail below, the coupler has a most attenuated terminal and the coupler connects the receiver, the transmitter and the antenna such that the receiver is connected to the most attenuated terminal.

FIGS. 2A, 2B and 2C show the appearance of a SART response at different ranges. FIG. 2A shows SART response from a relatively distant transponder (e.g., five to six miles). FIG. 2B shows SART response from a transponder at medium range (e.g., two to three miles). The echoes in FIG. 2B are wider than the echoes in FIG. 2A. FIG. 2C shows SART response for a transponder relatively close to the radar (e.g., less than one mile). In FIG. 2C, the echoes are even wider. FIGS. 2A-2C are the same as the prior art PRB (emergency) mode, but are different in the VRB non-emergency use of a device herein. The difference is that the dot string is much shorter having only two or three dots so that it is not mistaken for an emergency signal.

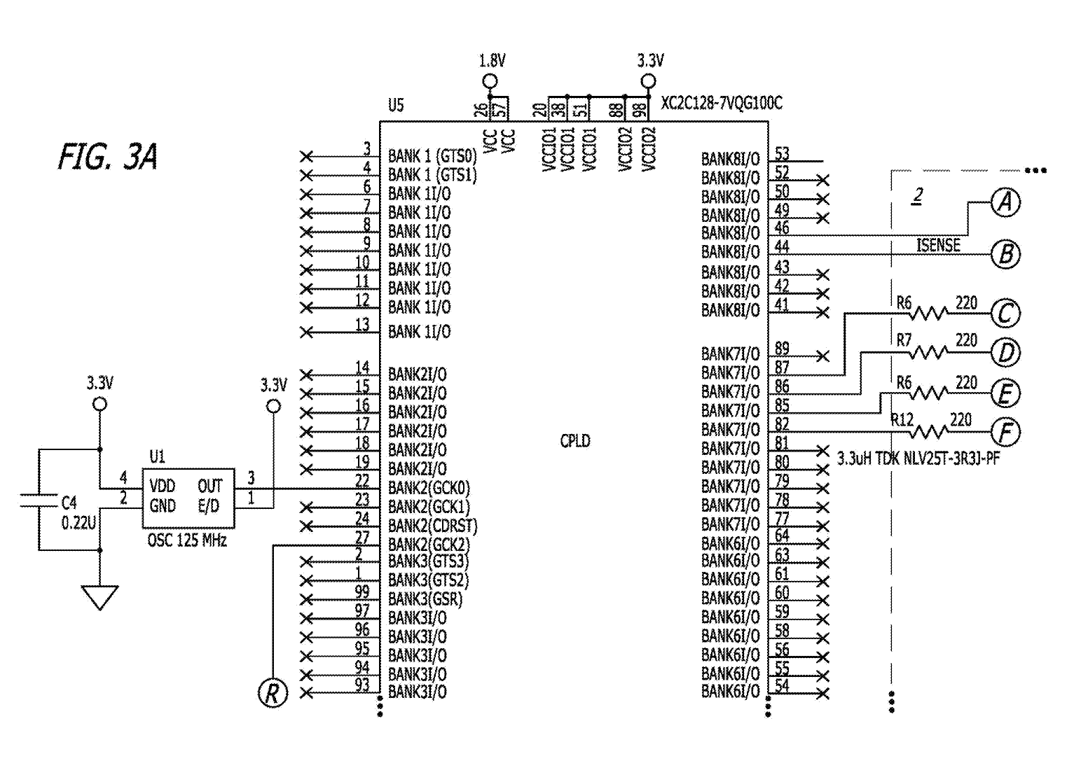

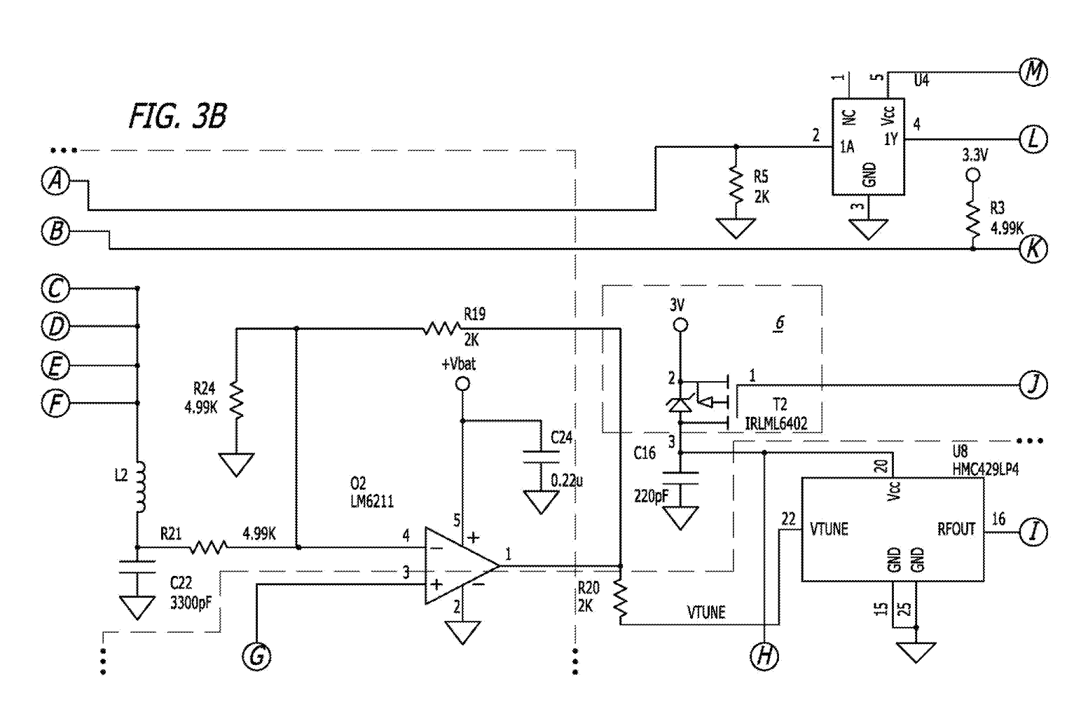

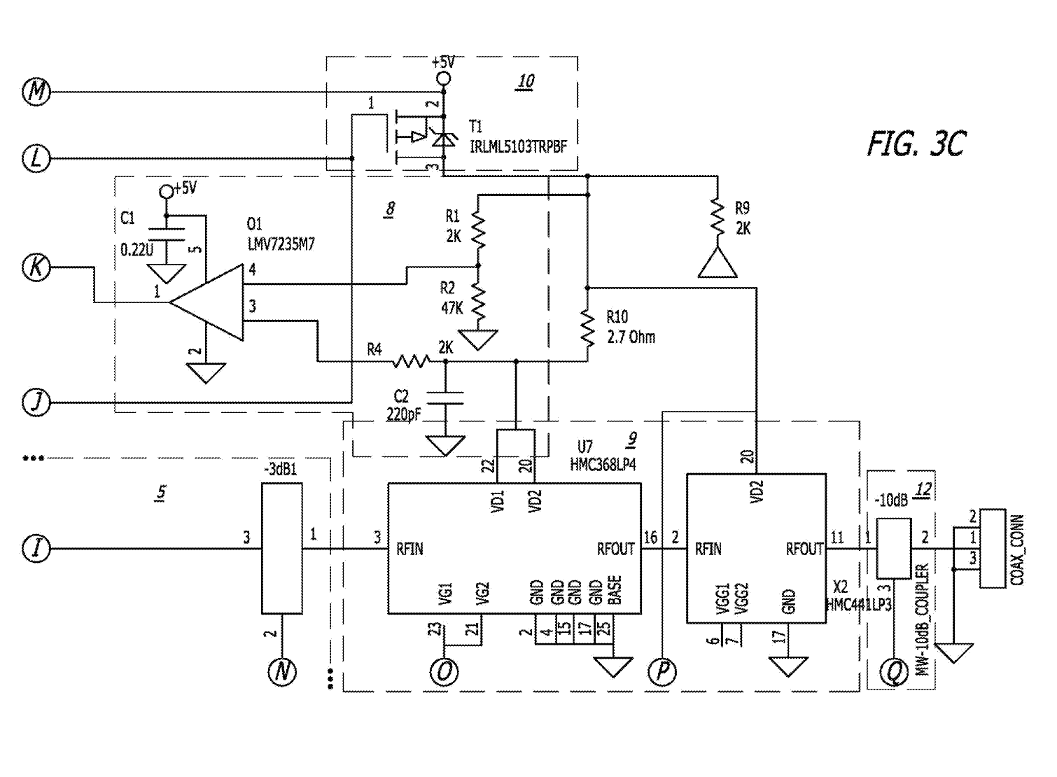

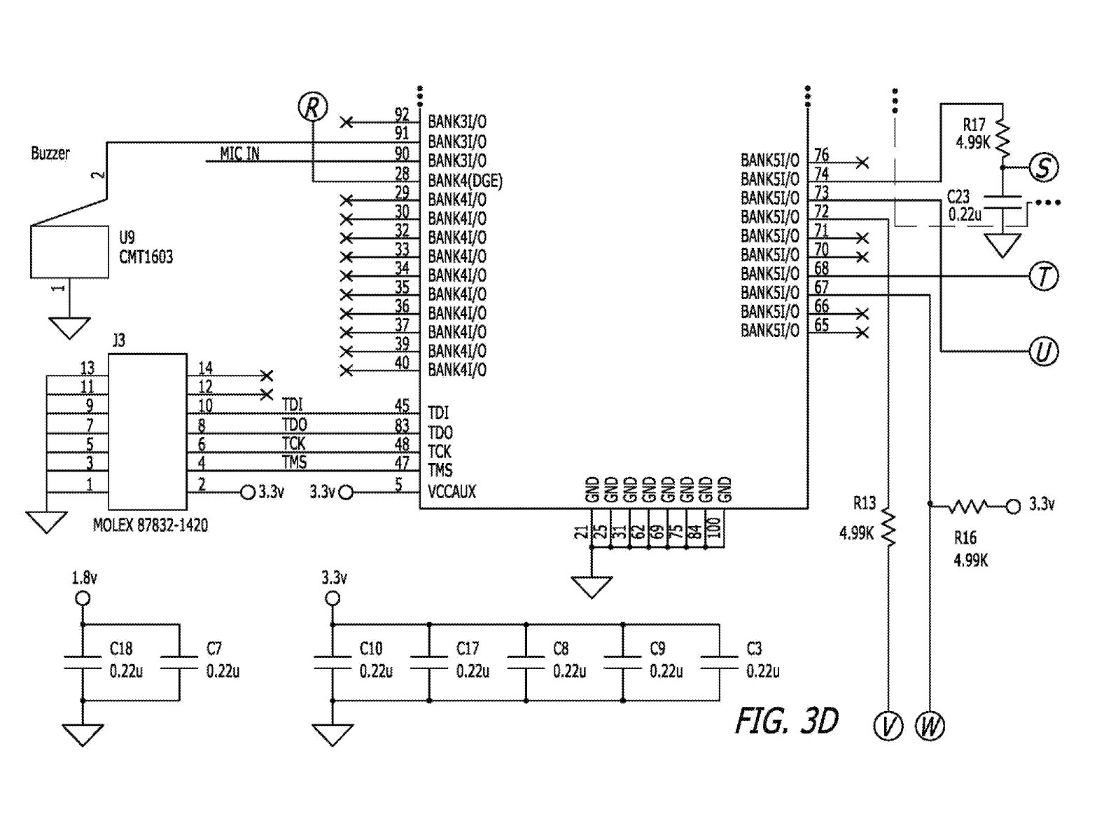

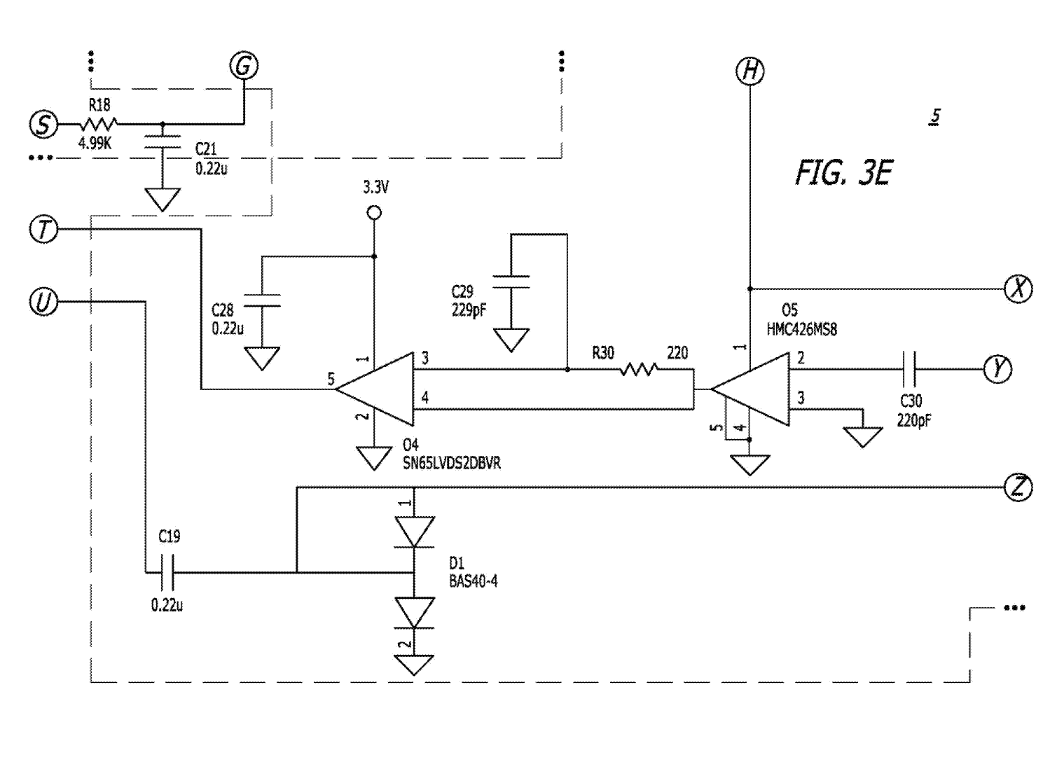

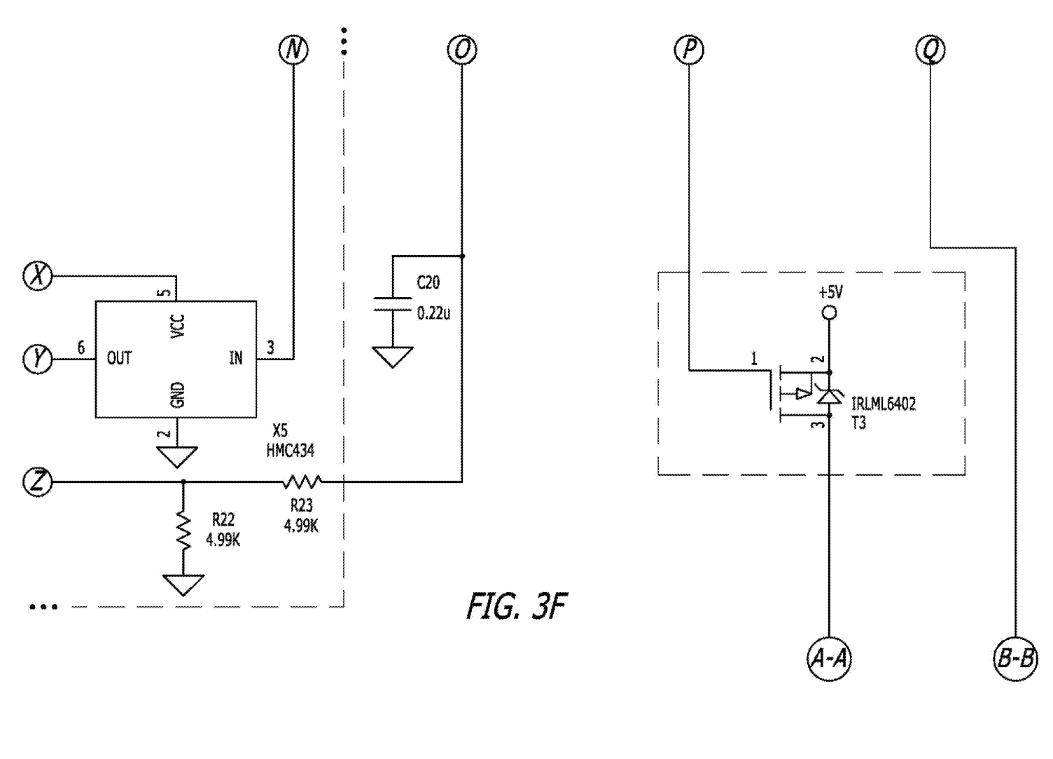

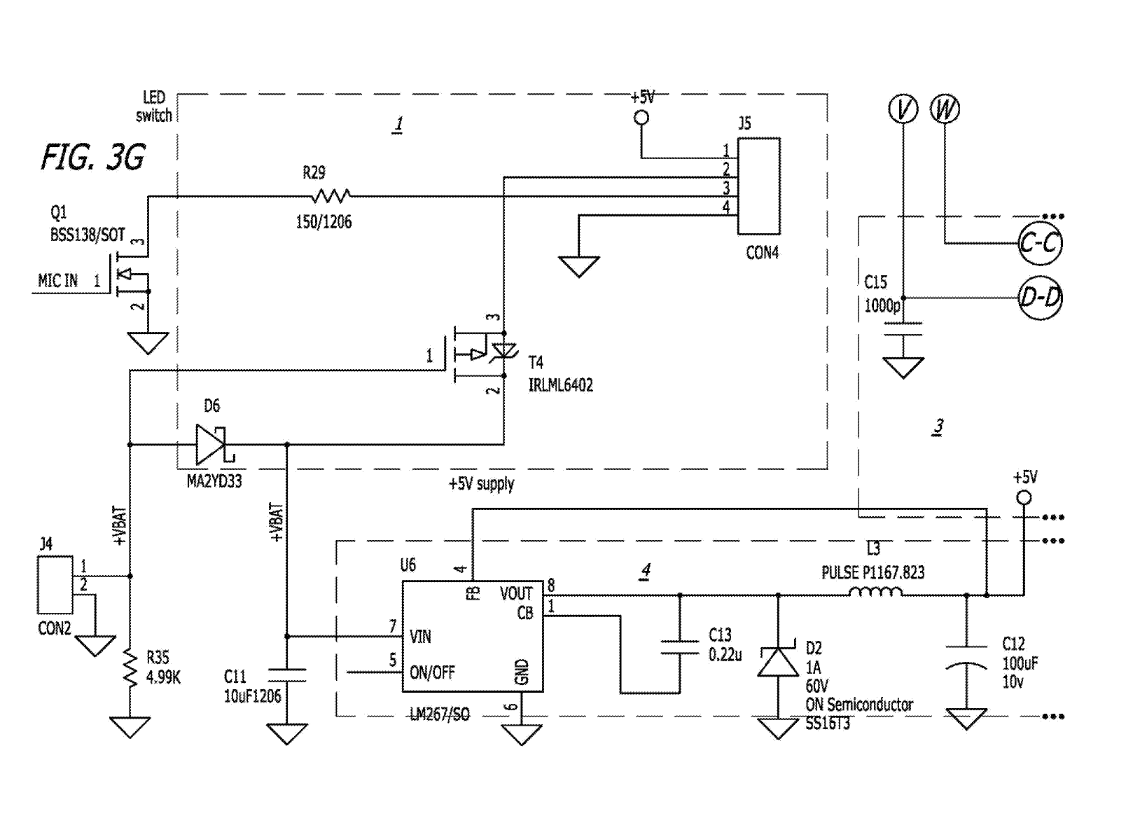

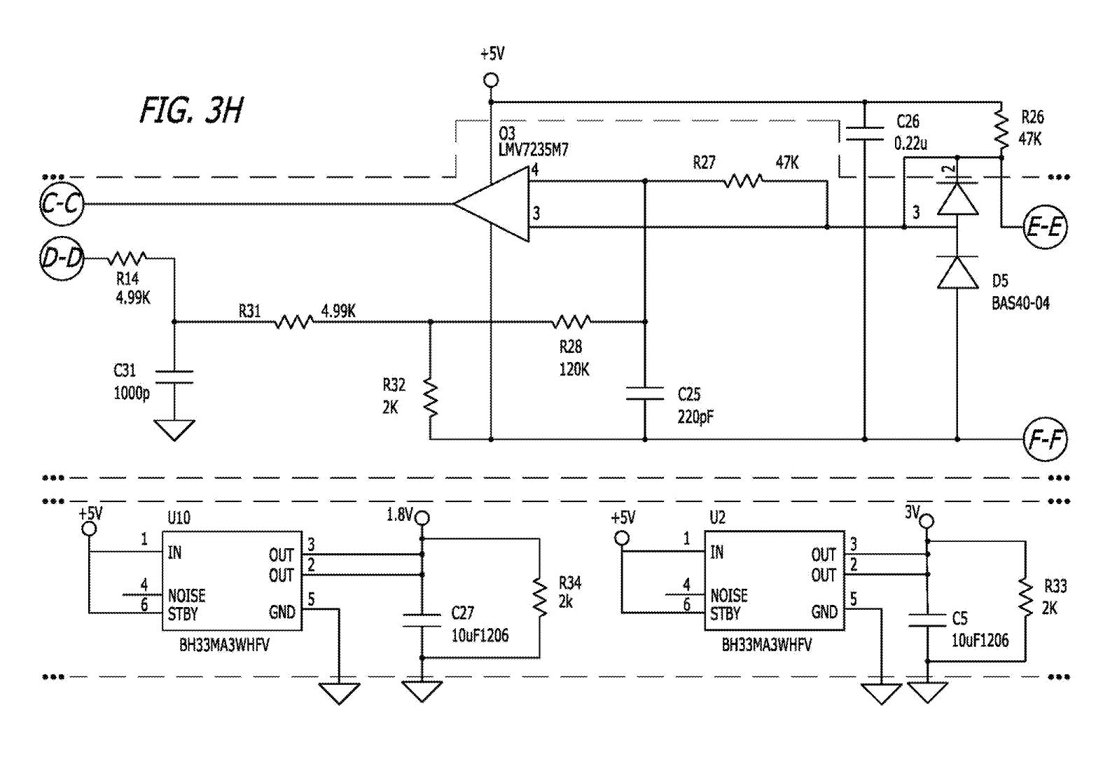

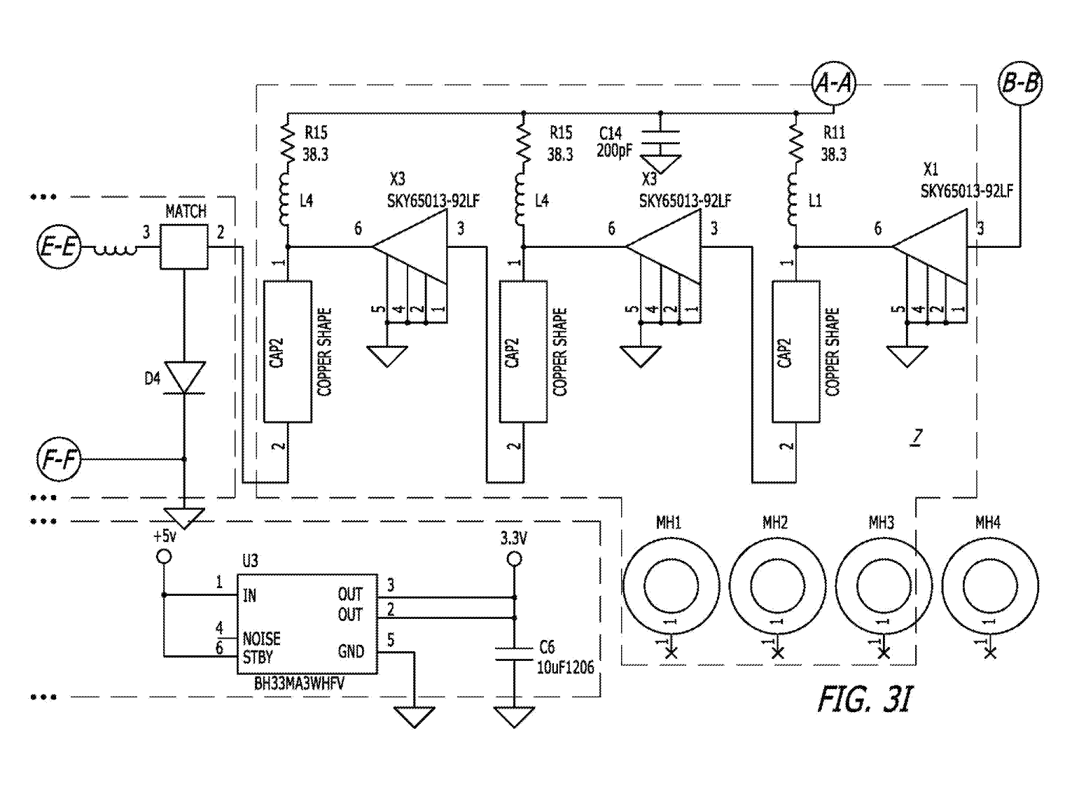

FIGS. 3A-3I form, as illustrated in FIG. 3, a schematic of a SART 200. In the SART 200, an “unswitched” antenna is used for both receive and transmit functions. The antenna is connected to the transmitter and to the receiver. The antenna is provided to the receiver circuit through an attenuator that protects the receiver circuit from the transmitter. In the standby state only the receiver portion of the SART is powered to reduce battery consumption. On receipt of a radar pulse the video amplifier and detector circuit cause the rest of the circuitry to become active and the unit switches to transmit mode. In this condition the indicator circuit illuminates an indicator LED and/or sounds an audio device to indicate that the device is transmitting. The output stage is fed by a Voltage Controlled Oscillator (VCO), whose frequency is determined by a sweep generator. When triggered by the detector the sweep generator turns on the VCO and causes it to produce a plurality (typically twelve) forward and reverse frequency sweeps before shutting down again. If no radar pulses are detected for a period of fifteen seconds the unit reverts to standby mode.

The antenna is coupled to the transmitter output without using a transmit/receive switch. The receiver is weakly coupled via a coupler, with significant attenuation so that there is insignificant drain of output RF power during transmission. The receiver sensitivity is increased to make up for the weak coupler attenuation. The received radar pulse is relatively strong, so even after attenuation by the coupler it is above the background noise of the detector. The amplification to compensate for the coupler loss costs much less than a T/R switch.

In the schematic of FIGS. 3A-3I, capacitors CAP1, CAP2 and CAP3 are blocking capacitors made out of copper shapes. The blocking capacitors are used circuit which may be used in this amplifier integrated circuit to block DC bias.

The coupler MW−10 dB may be a −10 dB capacitive coupler. The coupler couples the antenna to the receiver circuit in the X-and frequency range. Its construction, function and advantages are described in greater detail below.

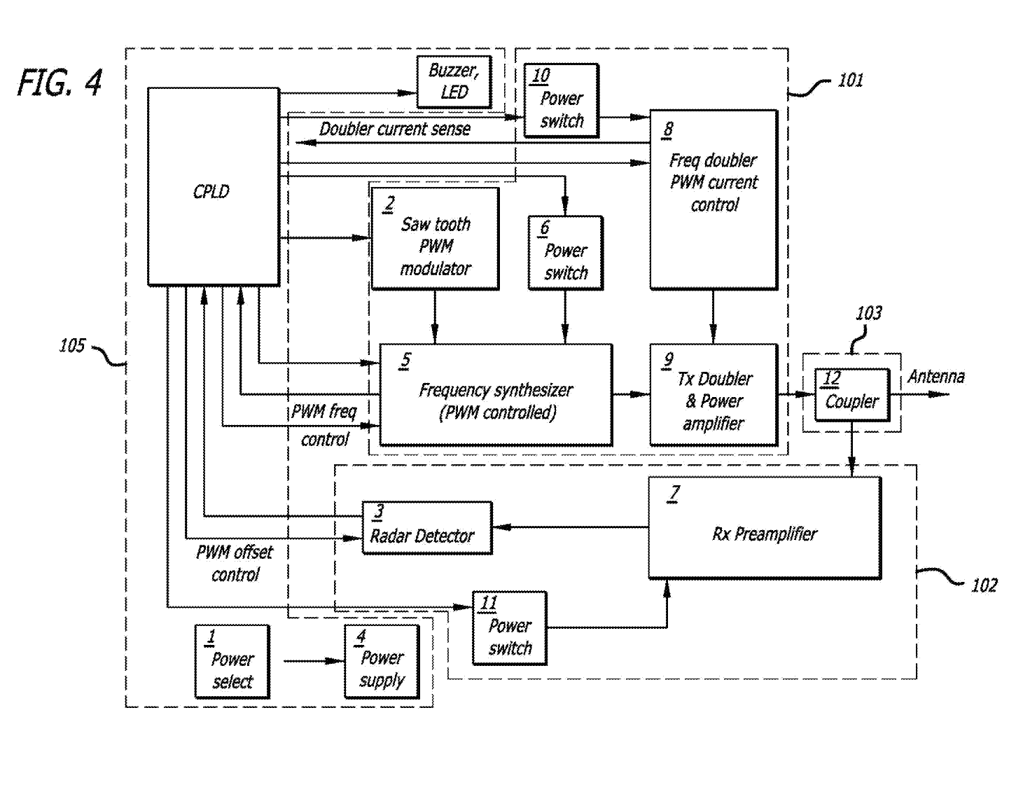

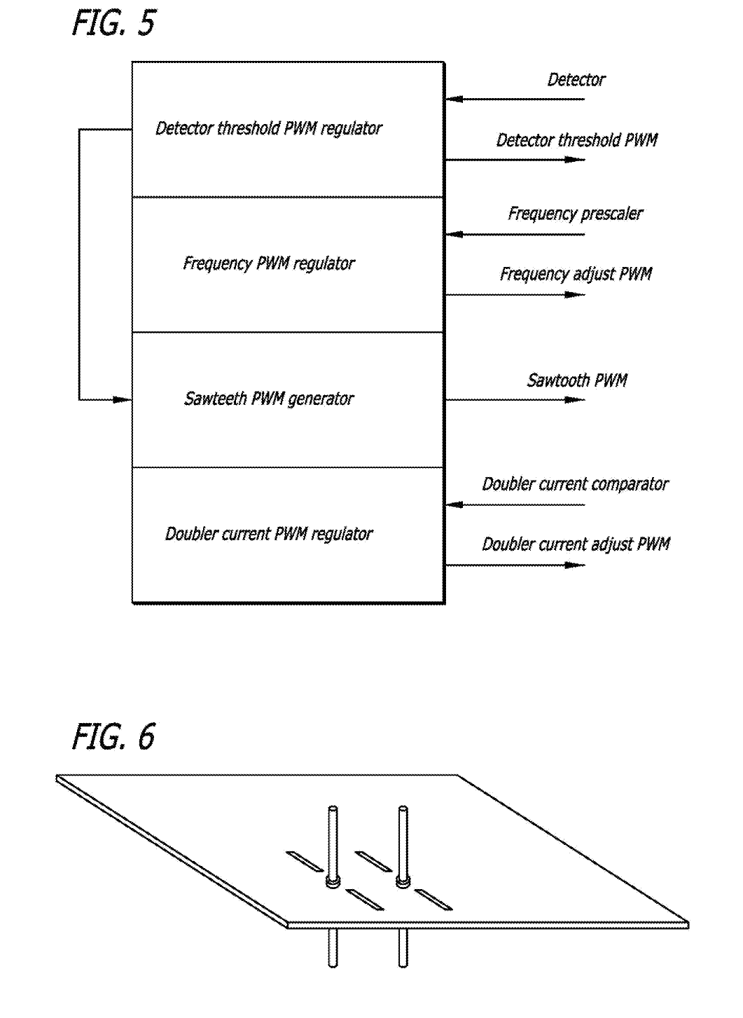

FIG. 5 is a block diagram of the CPLD U5 shown in FIG. 4, for example. The CPLD (U5 in the schematic of FIGS. 3A-3I) may provide the following functionalities: (a) The CPLD Detector threshold PWM regulator: at initialization, finds the noise detection threshold and then adjusts the detection threshold to prevent false alarms. (b) The Frequency PWN regulator at initialization, measures central frequency with sawteeth inactive and adjusts the VCO DC offset to correct central frequency. (c) The Sawteeth PWM generator is activated by detector signal, generates 4-phase PWM output to ramp VCO frequency; and stops after preprogrammed timeout. (d) The Doubler current PWM regulator; adjusts doubler supply current level at initialization time

FIG. 4 and aspects/components thereof will now be discussed. Referring thereto, the power switch allows automatic selection of input power from either 12V input or a battery. The above-mentioned PWM Saw tooth modulator may use ultrafast 4-phase PWM to sweep frequency; 4-phase PWM is more cost effective than Digital to Analog (D/A) converters as are known in the prior art. The sawtooth generator is generally cheaper, smaller and more power efficient than are the D/A converters. However, a D/A converter may be used herein though it would occupy more PCB real estate and add to the overall cost. The four-phase PWM generator may be optimized to the highest possible speed, and that is why it is referred to herein as “ultrafast.” As an example, it can include four CPLD outputs, four resistors and a filter which in turn includes an inductor and a capacitor.

The Radar detector may have a PWM offset adjustment by the CPLD to optimize sensitivity. The Power supply subsystem may regulate supply voltages for all csubcircuits.

The Frequency synthesizer regulates oscillator bias. The frequency may be pre-scaled and measured by the CPLD. A Regulation algorithm controls the low cost PWM circuit to keep correct frequency offset. This digital regulation method allows the Synthesizer off to be turned off when there is no transmission without losing control. The power switch saves battery power by turning the Frequency Synthesizer on only during transmission time.

The Rx Preamplifier is used to amplify the radar pulse. An amplification range may be between ten and sixty dB, and an example thereof is approximately thirty dB. This goes against conventional wisdom of using a heterodyne receiver and turns out to be more economical and more power efficient. Digital control of the frequency doubler current allows for the use of lower cost and more energy efficient doubler chip and allows for doubler power to be switched off when there is no transmission without losing control. The Tx Doubler and Power amplifier doubles the Frequency Synthesizer output frequency to required X-band and amplifies it before feeding to the antenna. The Preamplifier Power Switch turns the Preamplifier off during transmission to save power and prevent damage by transmitted power in the absence of the Tx/Rx Switch.

The Coupler essentially replaces the Tx/Rx switch as was used in the prior art. This is advantageous because those switches are very costly. The fact that radar pulse is a strong signal is used so when the Tx/Rx switch is replaced by this coupler which has attenuation of about 10 dB, there is still adequate signal for detection. Also coupler attenuation protects the receiver input from damage from strong radar pulse when distance is short, such as approximately forty feet or less, depending on the power of the radar, especially on larger commercial radars. The coupler, for example, may be made out of traces on the PCB, and not as a separate component.

The coupler acts as following: when power is transferred from or to the transmitter terminal, then the amount of power going to the receiver terminal is smaller than Tx power by the attenuation factor, and the rest of the power (1−attenuation) goes to the antenna. If the power is received from the antenna, then again the receiver only gets a small fraction of it equal to attenuation, and the bulk of the antenna signal (1−attenuation) is dumped in the transmitter that in the present circuit is disabled.

A workable range for the attenuation of the coupler can be between three and forty dB, and an example thereof is ten dB. The receiver sensitivity for SARTs is −50 dB. While a device disclosed herein may not be a code-defined SART, it has comparable sensitivity. At longer distances, the strength decreases further. Compared to the prior art, the minimum achievable detectable pulse strength for a device herein may be higher (that is, the maximum achievable sensitivity is lower), by the amount of the coupler attenuation. While this is disadvantageous compared to using the prior art T/R switch, the required sensitivity is much lower (the required minimum detectable pulse strength is much higher) than the limitations imposed by using the coupler. Thus, there is no performance penalty herein compared to the prior art. On the other hand, the maximum signal strength, when in close proximity to the radar, can be as high as +20 dB. Thus, the coupler helps protect the receiver circuitry when the device is too close to the radar.

The PCB multiple-bay Turnstile Antenna may have any number of bays, may be stacked, and may be manufactured using standard PCB processes. Referring to FIG. 6, the turnstile antenna may include a first bay, a second bay, PCB traces, and PCB mounted studs. It also may have a desirable “flattened” radiation pattern. One alternative is to integrate the antenna into the printed circuit board. Further, the turnstile antenna may be included on the printed circuit board.

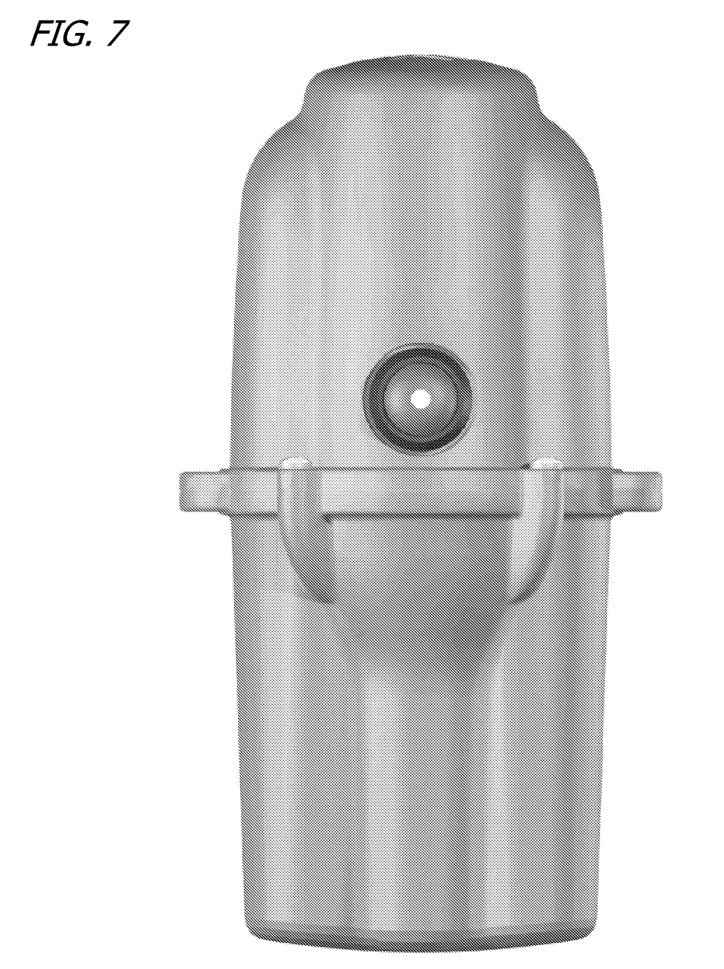

A transponder enclosure or housing is illustrated in FIG. 7. Referring thereto, it may be a two-piece water tight enclosure made of safety yellow polypropylene. The top and bottom pieces are shown by reference numerals. An O'ring keeps the enclosure water tight. Four enclosure screws secure the O'ring and flanges together. A hook is provided for a lanyard ring or other attachment, and one is provided on each side of the unit. The on/off switch has an LED in the center thereof. A buckle in the middle of the lanyard (not shown) allows the user to separate the lanyard in two pieces. And the clip by the lanyard ring is used to clip to life jacket webbing, belt loops, loops on foul weather gear, clothing or any garment or hooks on a boat, PWD, dive buoys or the like.

The SART signal is an internationally-recognized GMDSS 12-dot bearing line signal. The VRB and PRB do not use this signal since the present transponder may be GMDSS approved and it also need not be a SART. The signal can be any configuration 1-dot, 3-dots, etc any series, it can be factory programmed in any desired way. While the RTE shows a single “blip” on a radar, the present transponder can choose to do this or can program any series of bearing line dots.

The RTE can also have a dual power supply, namely an internal battery and 12V or 24V. The SART battery is a larger contributor to the weight of the SART. It can be a three cell shrink wrap, lithium, batter having a weight of three hundred and sixty two grams. In contrast a VRB battery herein may be three CR123 off-the-shelf camera batteries. While a typical SART is 33.25 ounces without the bracket, a VRB herein is only 8.5 ounces, making it usable as a personal device.

Different signal pattern for RTE. dual supply for RTE (internal battery and 12V or 24V)

A SART is used on ships and large lifeboats. In contrast, a VRB is for small watercraft, including jet skis. Signal is different from SART and is not to be confused with emergency signal. PRB is for Man Over Board and lost hikers. Both VRB and PRB must be compact and low cost to be viable on the market. Other uses include Boaters, Jet skiers (PWC). Kayakers, Hikers, Small vessels and any other watercraft, divers dive buoys.

The transponder herein may be cheaper and more compact than the prior art devices for one or more of all of the following reasons: no R/T switch, integrated multibay turnstile antenna, PWM modulator for sawtooth generation, use of lower cost PCT material, such as FR408, the elimination of the heterodyne in the receiver, and the use of digital CPLD-based methods for multiple functions, frequency synthesis for current regulation in the frequency doubler, for sawtooth pattern generating, for response function pattern generating (such as controlling the number of radar screen dots) and for automatic detector threshold tuning.

The VRB and PRB are the same products, just different marketing acronyms. These products are used as electronic target enhancers (Active RTE) based on SART (Search and Rescue Transponders) technology. The main differences between a SART and VRB or PRB are sizes, prices and uses. SARTs and Active RTE's are large (minimum twelve inches in length), expensive (starting at $1,100) and have applications for vessels only (usually larger vessels). SARTs meet GMDSS requirements and send a signal coded for emergency use only and are primarily used for large Yachts or GMDSS Ships (three hundred gross tons or more).

PRBs and VRBs are compact, priced starting at approximately $320, and can be used for personal or any size vessel and Personal Water Crafts (PWC). The PRB and VRB are designed to be used as more of a constant location signaling devices as opposed to an emergency locating device. As an example of the compactness, the dimensions of the VRB unit may be six inches tall, three inches wide, two inches deep and have a total volume of thirty-six cubic inches. In contrast, the “Sea-Me Active RTE” is 16.3 inches long, two inches in diameter and its control box is 4.5 inches by 2.5 inches by 1.3 inches. The permanent vessel mount has a volume of only 47.225 cubic inches. Also, in contrast, the average SART is 15.5 by 3.5 by 3.5 inches, having a total volume of one hundred fifty-three cubic inches.

VRBs and PRBs are not marketed as SARTs or as GMDSS Compliant since they do not meet the battery life or range requirements of SARTs or GMDSS approved devices.

The device described herein is “practical.” A European Mandate says that all vessels must use a radar reflector if “practical.” “Practical” is further defined as compact enough for use and cost effective. The VRB and PRB are also “Practical” due to their price point. Due to its design architecture, these units are ⅓ to ½ the cost of traditional SART (which start at about $1,100) and competing Active RTE (Radar Target Enhancers—SART Based radar reflectors) which also start at approximately $1,100. Neither of these devices is compact enough for personal or small vessel applications.

The VRB and PRB are both the only SART based products that are compact and can actually be used as “personal” Units. A traditional SART is designed for vessel mounting only and is too large to be used as a personal unit or in many cases to large to use on smaller vessels (such as small skiff, sailboats, kayaks, PWC, and so forth).

Pursuant to one aspect of the present disclosure existing SART technology is modified for use in 1) personal radar transponder for personal search and rescue (PRB—Personal Radar Beacon) and 2) in Active Radar Target Enhancer (RTE) for small and personal watercraft (VRB—Vehicle Radar Beacon). The SART technology is modified for low cost, compact size and energy efficiency to be suitable for personal and small craft market. One improvement over prior art is elimination of the R/T switch which is a major cost driver. The disclosed improvements could also be reused in traditional SARTs. This method can be adapted for other modifications of SART technologies as would be apparent to those skilled in the art, for example as new product definitions and new business and other methods.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

Thus, from the foregoing detailed description, it will be evident that there are a number of changes, adaptations and modifications that come within the province of those skilled in the art. The scope of the disclosure includes any combination of the elements from the different species, embodiments, functions, sub-systems and/or subassemblies disclosed herein, as would be within the skill of the art. It is intended that all such variations not departing from the spirit thereof be considered as within the scope of this disclosure.

1. A radar transponder comprising:
an antenna;
a transmitter;
a receiver;
a controller configured to activate the transmitter when the receiver receives a radar pulse; and
a radio frequency coupler connecting the antenna, the transmitter and the receiver.

2. The transponder of claim 1 wherein the coupler has a most attenuated terminal and the coupler connects the receiver, the transmitter and the antenna such that the receiver is connected to the most attenuated terminal.

3. The transponder of claim 1 wherein the transponder is a search and rescue transponder.

4. The transponder of claim 1 wherein the coupler has an attenuation of between three and forty dB.

5. The transponder of claim 1 wherein the coupler has an attenuation of approximately ten dB.

6. The transponder of claim 1 wherein the coupler has an attenuation of nine-eleven dB.

7. The transponder of claim 1 wherein the receiver has a sensitivity of −50 dBm.

8. The transponder of claim 1 wherein the transponder is a personal radar transponder.

9. The transponder of claim 1 wherein the transponder is free of a transmit/receive switch.

10. The transponder of claim 1 wherein the attenuation of the coupler protects the receiver from transmitter power and from excessive antenna input power from a radar that is close to the transponder.

11. The transponder of claim 1 wherein the transponder uses a frequency range of 9.2-9.5 GHz.

12. The transponder of claim 1 wherein the receiver includes an amplifier configured to amplify the radar pulse.

13. The transponder of claim 12 wherein the amplifier amplifies the radar pulse between ten and sixty dB.

14. The transponder of claim 12 wherein the amplifier amplifies the radar pulse approximately thirty dB.

15. The transponder of claim 1 wherein the receiver has no heterodyne and a preamplified or not-preamplified signal goes straight to a detector.

16. The transponder of claim 1 wherein the transmitter includes a frequency synthesizer.

17 The transponder of claim 1 including a power switch which selects input power from either 12V or 24V input or a battery.

18. The transponder of claim 1 wherein the receiver includes a sawtooth generator which is implemented as a 4-phase pulse width modulator.

19. The transponder of claim 18 wherein the sawtooth generator is optimized for speed and low ripple.

20. The transponder of claim 1 wherein the signal used is other than a 12-dot bearing line signal.

21. The transponder of claim 1 wherein the signal used has fewer than twelve dots.

22. The transponder of claim 21 wherein the signal is a 1-dot, 2-dot or 3-dot signal.

23. The transponder of claim 1 wherein the signal used is a series of bearing line dots.

24. The transponder of claim 1 wherein the signal is a single blip on a radar.

25. The transponder of claim 1 wherein the transponder is adapted to be worn by an individual.

26. The transponder of claim 1 including a printed circuit board for the receiver, the transmitter, the controller, the coupler and the controller.

27. The transponder of claim 1 wherein the transponder has a total volume of generally 36 cubic inches or less.

28. The transponder of claim 1 wherein the greatest of the height, width and depth dimensions of the transponder is approximately no greater than six inches.

29. The transponder of claim 1 wherein the transponder has dimensions of approximately six by three by two inches or less.

30. The transponder of claim 1 wherein the transponder is adapted for use by or in one or more of small skiffs, sailboats, kayaks, personal water craft, jet skiers, hikers, divers and dive buoys.

31. The transponder of claim 1 wherein the transponder has a total weight no greater than a pound.

32. The transponder of claim 1 wherein the transponder has a total weight of generally 8.5 ounces or less.

33. The transponder of claim 1 further comprising an enclosure for the antenna, transmitter, receiver, controller and coupler.

34. The transponder of claim 33 wherein the antenna, transmitter, receiver, controller and coupler are mounted on a printed circuit board substrate.

35. The transponder of claim 33 further comprising clipping means for clipping the enclosure to a hooks or loops of a human user or intended structure.

36. The transponder of claim 33 further comprising clipping means for clipping the enclosure to a belt buckle, life jacket webbing, or clothing loops/hooks of the user.

37. The transponder of claim 33 further comprising a lanyard attached to the enclosure for carrying by a human user.

38. The transponder of claim 33 wherein the enclosure is a two-piece water-tight plastic enclosure.

39. The transponder of claim 1 including and being powered by three 3.0 volt Lithium batteries.

40. The transponder of claim 1 including and being powered by a 3 cell SART battery.

41. The transponder of claim 1 wherein the transponder is a vessel or vehicle/vessel radar transponder.

42. The transponder of claim 1 wherein the transponder is an active radar target enhancer transponder.

43. The transponder of claim 1 wherein the antenna is a turnstile antenna.

44. The transponder of claim 43 wherein the antenna is made completely out of PCB traces.

45. The transponder of claim 43 wherein the turnstile antenna is made of PCB traces and pPSB mounted studs.

46. The transponder of claim 43 wherein the antenna has at least two bays for directivity and higher gain.

47. A radar transponder comprising:
a turnstile antenna;
a transmitter;
a receiver; and
a controller configured to activate the transmitter when the receiver receives a radar pulse.

48. The transponder of claim 47 wherein the antenna is an integrated PCB surface-mounted multi-bay turnstile antenna

49. The transponder of claim 47 wherein the antenna is made completely out of PCB traces.

50. The transponder of claim 47 wherein the turnstile antenna is made of PCB traces and pPSB mounted studs.

51. The transponder of claim 47 wherein the antenna has at least two bays for directivity and higher gain.
